(19) United States
(12) Patent Application Publication
(10) Pub. No.: US 2019/0095316 A1
(43) Pub. Date: Mar. 28, 2019

(54) TECHNIQUES TO PROVIDE DEBUG TRACE INFORMATION TO A MANAGEMENT HOST

(71) Applicant: INTEL CORPORATION, SANTA CLARA, CA (US)

(72) Inventors: SHANKER RAMAN NAGESH, Bangalore (IN); RAMAMURTHY KRITHIVAS, Chandler, AZ (US); MANDIRA KUMAR SATHANANTHAM, Bangalore (IN)

(73) Assignee: INTEL CORPORATION, SANTA CLARA, CA (US)

(21) Appl. No.: 15/714,963

(22) Filed: Sep. 25, 2017

(51) Int. Cl. G06F 11/36; G06F 11/34; H04L 29/08

(52) U.S. Cl. CPC G06F 11/3636; G06F 11/3664; G06F 2009/45591; H04L 67/025; G06F 11/3495

(57) ABSTRACT

Various embodiments are generally directed to an apparatus, method and other techniques to receive debug trace information via one or more pins, generate a packet comprising the debug trace information and a header, the header comprising header information to send the packet to a device coupled via one or more network connections, determine a location in a data buffer of an interface controller for the packet, and write the packet to the data buffer of the interface controller at the location.

### TECHNICAL FIELD

Embodiments described herein generally relate to techniques to provide debug trace information to a remote host via one or more packets.

### BACKGROUND

Modern systems, such as large data processing centers and cloud computing systems typically manage many computing devices from a remote or central location. These systems require high availability uptimes and typically must provide a standard level of performance, which may be in accordance with a service level agreement. Therefore, enabling communication of diagnostics to remote systems capable of managing and solving issues is critical and desirable. However, performing debug and trace operations and collecting the data can be difficult and fail due to failures at the computing devices themselves. Thus, embodiments are directed to solving these and other problems.

### BRIEF DESCRIPTION OF THE DRAWINGS

FIG. 1 illustrates an example embodiment of a system.

FIG. 2 illustrates an example of a device.

FIG. 3 illustrates an example of a first logic flow.

FIG. 4 illustrates examples of a second logic flow.

FIG. 5 illustrates an example of a third logic flow.

FIG. 6 illustrates an example of a fourth logic flow.

FIG. 7 illustrates an example of a fifth logic flow.

FIG. 8 illustrates an example embodiment of a device.

FIG. 9 illustrates an exemplary embodiment of a first computing architecture.

### DETAILED DESCRIPTION

Embodiments discussed herein are related to mechanisms to capture debug trace information and to send the debug trace information to remote devices dynamically and in real-time in packets. The mechanisms implemented, as discussed herein, send the debug trace information to the remote devices without the need to store the debug trace information in main memory. Thus, access to the debug trace information is available even in the case of post-failure scenarios when access to main memory is not available, and no special real-estate requirements to accommodate probes within the target platform are need.

Moreover, embodiments include, a controller, such as a platform controller hub (PCH) controller, to receive debug trace information from a processor component via packet trace interface (PTI) pins. The PTI pins may be low power pins to communicate the debug trace information to the controller, as discussed herein. The controller may generate one or more packets comprising the debug trace information, each packet including a header; the header includes header information to send the packet to a device accessible via one or more network connections. In some embodiments, the one or more packets are Ethernet packets and are sent to a remote system such as a datacenter management host to perform debugging operations, e.g., determine the source of the failure or problem.

The controller, to send the packets to a remote system, utilizes an interface controller coupled with an interface and the one or more network connections. More specifically, the controller determines a location in a data buffer of the interface controller to store the packet for communication to the remote system. The controller may determine a base address to store the packet in the data buffer of the interface controller. The base address indicates the location to store the packet and is set in a register of the controller. The controller may read the register and determine the base address, for example. The controller will then write the packet into the data buffer of the interface controller at the location and based on the base address. The controller may send the packet to the interface controller including the data buffer via an interface between the controller and the interface controller. Embodiments are not limited in this manner. These and other details will become more apparent in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

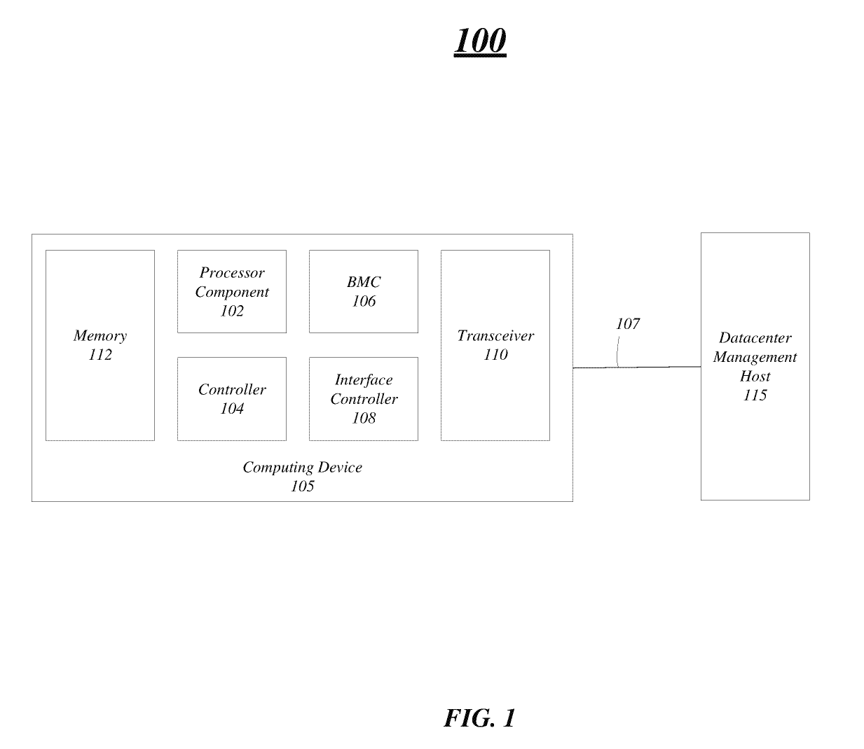

FIG. 1 illustrates an example embodiment of a system 100 in which aspects of the present disclosure may be employed. The illustrated example includes a computing device 105 coupled with a datacenter management host 115 via one or more interconnects 107. The one or more interconnects 107 may be one or more network connections part of a network architecture that may support Ethernet communication and other types of communication, e.g. Omni-Path. In embodiments, the interconnects 107 may support communication via fiber-optic and electrical connections and communication pathways. The network architecture may include other networking devices including switches, routers, and so forth. Embodiments are not limited in this manner.

The datacenter management host 115 may include one or more servers or processing devices to process information and data. In embodiments, the datacenter management host 115 may perform administrative tasks for the system 100. In one example, the datacenter management host 115 may determine resources, such as the computing device 105 to process workloads. The datacenter management host 115 may provide monitoring and/or troubleshooting tasks for the system 100.

In embodiments, the datacenter management 115 may collect error and debugging information from the computing device 105 to detect and determine causes of failures of the computing device 105. In debugging many of the failures, it becomes important to be able to remotely collect the debugging information from the computing device 105 by a system monitoring operations performed by the computing device, such as the data management host 115. One of the biggest problems in current systems is that all the trace aggregator instances, e.g. debug trace information, is stored in the memory 112 of the computing device 105. There are cases in computing device failures when access to memory 105 and debug information is not available. For example, information may not be collected by the processor component 102 due to a hang in the interconnect path between the memory 112 and the processor component 102, a problem with the memory 112, and/or a problem with a memory controller for the memory 112, for example. It is therefore important to have a solution which allows the debug trace information to be communicated to remote systems and management hosts that are not dependent on the interconnect paths between the processor component 102 and memory 112, and to continually stream this debug trace information over network connections to the remote systems and data management hosts. Thus, as will be discussed in more detail below, embodiments include transporting the debug trace information as packets via Ethernet, for example, and adding information in the transported packets to allow for the data management host 115 to detect any corruption of information transmitted.

In various embodiments, the computing device 105 may be embodied as any type of computing device, including a personal computing, a desktop computer, a tablet computer, a netbook computer, a notebook computer, a laptop computer, a server, server farm, blade server, or any other type of server, and so forth. Embodiments are not limited in this manner.

In some embodiments, the computing device 105 may include one or more processor component 102 which may include one or more cores and registers to process and store information for the computing device 105. The processor component 102 may include memory and cache to store information and data for processing. Embodiments are not limited to these components, for example, the processor component 102 may also include components such as a control unit, a logic unit, arithmetic unit, internal clocks, logic gates, buses, and so forth.

The processor component 102 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. In some embodiments, the processor component 102 may be connected to and communicate with the other elements and components of the computing system 105 via an one or more interconnects, such as one or more buses, control lines, and data lines. For example, the processor component 102 may be coupled to a controller 104, a baseboard management controller (BMC) 106, an interface controller 108, and so forth. Embodiments are not limited to these components, and the processor component 102 may be coupled with other components, such as memory, input/output (I/O) controllers, and other controllers.

In embodiments, the processor component 102 may provide fault and debugging capabilities for the computing system 105. For example, the processor component 102 may capture debug trace information including, but not limited, to information about the processor component's 102 hardware and software running on one or more threads of the processor component 102. The debug trace information may include control flow tracing and store cycle count and timestamp information. Also, the debug trace information may include indications of mode changes, such as changes to control registers, virtual machine control structure, transactional synchronization extensions. The debug trace information may capture changes to synchronization points, e.g. time stamp counter, frequency software context, and so forth. Embodiments are not limited in this manner, and other information concerning the processor component 102 and other components of the computing device 105 may be captured in the debug trace information.

The processor component 102 may send the debug trace information to the controller 104. For example, the processor component 102 may utilize one or more pins coupled with one or more pins of the controller 104 to communicate the debug trace information.

The controller 104 may be an integrated circuit, such as platform controller hub (PCH) or southbridge controller, to control data paths to support functions used in conjunction with the processor component 102. In some instances, the controller 104 may control clocking, the display interface (flexible display interface), a media interface (direct media interface), I/O functions, and so forth. In embodiments, the controller 104 may receive the debug trace information and packetize it for communication to a remote system, such as the datacenter management host 115 coupled via interconnect 107. Moreover, the controller 104 may store the packetized debug trace information in local, e.g. controller's 104, memory or registers until the debug trace information and the interface controller 108 is ready to be communicated to the datacenter management host 115. The controller 104 may send the packetized debug trace information to the interface controller 108 for communication to remote device or system, such as the datacenter management host 115. The controller 104 may also determine descriptor information associated with the debug trace information via handshake operation including reading a register of the controller 104 and sending the descriptor information to the interface controller 108. The interface controller 108 may be an Ethernet controller or media access control (MAC) controller and may receive the packetized debug trace information and descriptor information and store the information in one or more buffers. The interface controller 108 may read the buffer(s) and communicate the debug trace information via transceivers 110. The transceiver 110 may include circuitry to enable communication, e.g. sending and receiving, of information within a network, for example. In embodiments, the transceiver 110 may communicate information electrically and/or optically. Embodiments are not limited this manner.

The computing device 105, which may be main memory or system memory used by the processor component 102 to to write and read data. The memory 112 may be one or more of volatile memory including random access memory (RAM) dynamic RAM (DRAM), static RAM (SRAM), double data rate synchronous dynamic RAM (DDR SDRAM), SDRAM, DDR1 SDRAM, DDR2 SDRAM, SSD3 SDRAM, single data rate SDRAM (SDR SDRAM), and so forth. Embodiments are not limited in this manner, and other memory types may be contemplated and be consistent with embodiments discussed herein. For example, the memory 112 may be a three-dimensional crosspoint memory device, or other byte addressable write-in-place nonvolatile memory devices. In embodiments, the memory devices may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory based device, a magnetic tunneling junction (MTJ) based device, a DW (Domain Wall) and SOT (Spin-Orbit Transfer) based device, a thyristor-based memory device, or a combination of any of the above, or other memory.

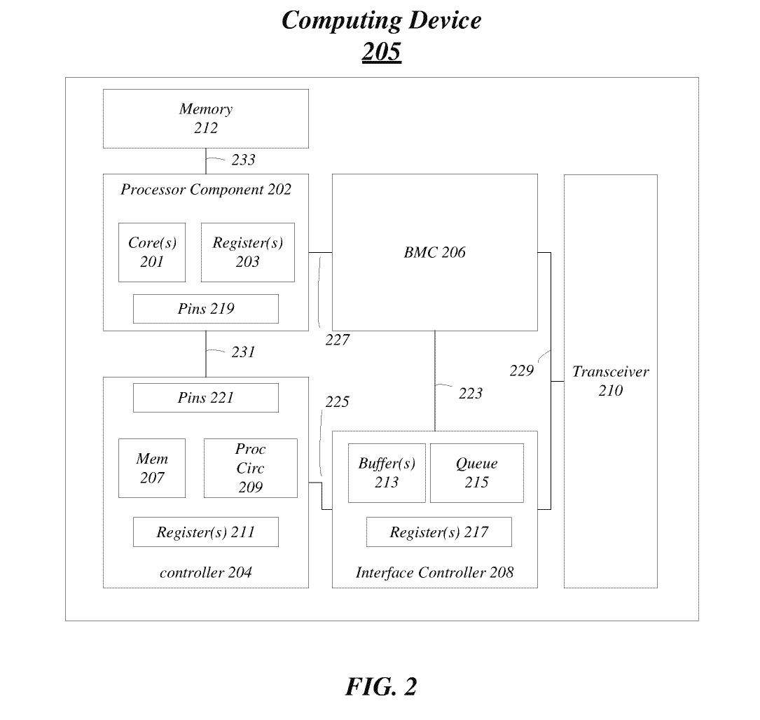

FIG. 2 illustrates an example of a computing device 205, which may be the same as or similar to computing device 105 discussed in FIG. 1. Computing device 205 may process information and data, determine debug trace information, and provide the debug trace information to remote systems for further analysis. The computing device 205 includes a processor component 202, a controller 204, a BMC 206, an interface controller 208, and memory 212. The computing device 205 may also include a transceiver 210 to communicate information and data including the debug trace information to the remote systems and devices.

In embodiments, BMC 206 may enable and disable the debugging and trace features for the computing device 205 based on information received from a remote system, such as the datacenter management host 115.The BMC 206 may receive data from a remote system via a BMC local area network (LAN) interface to turn on/off debugging and tracing for the processor component 202. In one example, the BMC 206 may receive the indication in one or more Ethernet packets. Note that in some embodiments, the indication may be generated locally, e.g. by an operating system executing on the computing device 205. For example, the operating system may detect an error or problem and turn on the debugging and tracing for the computing device 205 to send the debug trace information to the remote system.

The BMC 206 may configure one or more registers 203 of the processor component 202 to enable or disable debugging and tracing via an interface 227. The interface 227 may be a platform environment control interface (PECI) to enable the BMC 206 to communicate with the processor component 202. The BMC 206 may send one or more mailbox commands (requests) to the processor component 202, and the processor component 202 may include a PECI mailbox handler to receive and handle the commands including setting one or more of the registers 203 to enable/disable the debugging and tracing. This may include setting the one or more registers 203 to indicate the signals which need observation and setting up triggers to start/stop tracing of on the processor component 202. The processor component 202 may include logic to configure debug registers of registers 203 based on PECI mailbox requests coming from the BMC 206, for example.

In embodiments, the BMC 206 may also determine header information for packets including the debug trace information to be communicated to a remote system. In some embodiments, the header information may be determined from the remote system itself, and include Ethernet header information including the address, e.g. internet protocol (IP) address, MAC address and other network address details of the remote system. The BMC 206 may configure or set the header information in one or more registers 211 of the controller 204 such that the controller 204 may include the header information in the packets having the debug trace information to send to the remote system. For example, the controller 204 may append to the assembled trace cache lines including the debug trace information with an Ethernet header in the controller's 204 internal memory and cause the packet to be sent to a remote system.

In embodiments, the processor component 202 including one or more cores 201 may collect the debug trace information by monitoring various threads, processing circuitry, registers, gates, and so forth and dynamically sends the debug trace information to controller 204 for further communication to remote devices. The processor component 202 does not utilize the memory 212 coupled via interconnect 233 to store the debug trace information dynamically sent to the controller 204. Thus, failures caused or related to memory 212 and a corresponding memory controller themselves are captured by the processor component 202 and can be provided to the remote devices.

In embodiments, the processor component 202 sends the debug trace information to the controller 204 via pins 219 coupled with pins 221 of the controller 204 over interface 231, which may be a lower power trace interface. The pins 219 and 221 may be low power pins (packet trace interface (PTI) pins) and couple low power trace transport wires of the processor component 202, for example. The processor component 202 may communicate the debug trace information if a bit is set in the processor component 202. If set, the processor component 202 may send the debug trace information to the controller 204 without any additional configuration changes. Embodiments are not limited in this manner, and other bits may be utilized to cause the debug trace information to be communicated to the controller 204.

The processor component 202 utilizing the interface 231 sends a number of signals including the debug_data signal, the debug_vld signal, the debug_clk signal, and the debug_credit_avail signal to communicate the debug trace information. Table 1 below illustrates these with corresponding descriptions.

TABLE 1

| | | Direction (with respect |
|---|---|---|
| Signal Name | | to processor |
| (Pin Name) | Description | component 202) |
| debug_data [0:15] | Data for debug trace | Output |
| | information | |
| debug_vld | Valid qualifier asserted | Output |
| | when sampled data is valid | |
| debug_clk | Clock signal | Output |
| debug_credit_avail | Asserted if controller 204 | Input |
| | does not have space to | |
| | accept additional debug | |
| | trace information | |

In some embodiments, the controller 204 may sample the debug trace information. In these instances, one or more of the pins 219 and 221 may be configured or reconfigured to support two way/bi-directional communication. Thus, the pins associated with the debug_data, debug_vld, and debug_clk may be configured to sample debug trace information from the processor component 202 and may be set as Input/Output pins. The debug_credit_avail signal may be driven from controller 204 to indicate to the processor component 202 whether to send more debug trace information or not based on available space.

The controller 204 may receive the debug trace information from the processor component 202 and store the information internally, e.g. in registers 211, to process and generate the packets. The controller 204 including processing circuitry 209 may generate one or more packets including the debug trace information. In an example, the one or more packets may be Ethernet packets subject to a maximum packet size for Ethernet communication. The maximum packet size may be set in one or more of the registers 211 and used by the controller 204 to generate the one or more packets. The controller 204 may also append the header information to each of the one or more packets, the header information may include the Ethernet header values and indicate an address of the destination for a packet.

The controller 204 may also add a sequence number or sequence information to each of the packets to enable the remote system or receiving device to put the packets in the correct sequence. In embodiments, the sequence information indicates a relative location with respect to other packets in a sequence of packets sent to the remote system. The controller 204 may store the finalized one or more packets in memory 207 and registers 211 for communication to the interface controller 208. As previously mentioned, the controller 204 may assert the debug_credit_avail signal if the storage for the one or more packets is full and unavailable to store additional packets. The processor component 202 may wait to send additional debug trace information until the debug_credit_avail signal is de-asserted. Note that the processor component 202 may send and the controller 204 may receive the debug trace information in real-time as a stream of information. Moreover, the controller 204 may generate the one or more packets in real-time as additional debug trace information is received.

In embodiments, the controller 204 may also encrypt each of the one or more packets. To enable secure communication of the packet and their contents, the controller 204 may use a shared key exchanged as part of the secure configuration via the BMC 206. For example, the BMC 206 receives a public key used from a remote system, such as data management host, and provide it to the controller 204 for use in encrypting the packets. The remote system may use a private key to decrypt the contents of the packets.

The controller 204 also assembles packet descriptors that are used by the interface controller 208. For example, the controller 204 may perform a handshake with the interface controller 208 to determine descriptor information, and write the descriptor information to a descriptor buffer of buffer(s) 213 of the interface controller 208. The descriptor information will point to the location in the data buffer of buffer(s) 213 for packets.

The controller 204 may send the packets and the descriptor information to the interface controller 208 for further communication to a remote system via the interface 225, e.g. Intel On-Chip System Fabric (IOSF) interface. In embodiments, the controller 204 may determine a base address, which may be the starting address of a data buffer of buffer(s) 213 to write the packets. For example, one or more of registers 211 may be programmed with the base address of the interface controller 208 by one or more of the BIOS, operating system, an application, etc. The controller 204 including the processing circuitry 209 may read the base address to write the packets to the data buffer of buffers 213. The one or more registers 211 may also indicate how many packets, e.g. the space available in the data buffer that the controller 204 may write to the interface controller 208. The controller 204 may also write the descriptor information associated with the packets including the debug trace information into a descriptor buffer of buffer(s) 213. As mentioned, the descriptor information points to the packets in a data buffer of buffers 213 having the packets for communication to the remote system.

The controller 204 may also cause communication of the packets to the remote system. For example, the controller 204 may write to one of the registers 217, such as a Transmit Queue register, to trigger the actual transfer to the remote system. The controller 204 may write to the transmit queue register after completion of the writes of the packets & descriptor information to the interface controller 208. The transmit queue register may be a programmed register offset from the base address where the controller 204 will write the data.

The interface controller 208 may send the packets to the remote system via the transceiver 210. In embodiments, the interface controller 208 may send the packets and perform a descriptor fetch scheme. The descriptor fetch scheme is different than pre-existing fetch schemes for several reasons. For example, the descriptor information is written to the descriptor buffer of buffers 213 local to the interface controller 208, not the main memory as previously done. Thus, the interface controller 208 fetches the descriptor information associated with the packets from internal memory of the interface controller 208, e.g. buffers 213.The size of the internal storage, e.g. buffers 213, within the interface controller 208 may be at least sixty-four (64) kilobytes (KBs) which will allow for at least two-to-three sixteen (16) KB Ethernet packets.

The interface controller 208 may fetch the descriptor information including descriptors written into the descriptor buffer and cause transmission of the packets onto the network to the remote system. The remote system may receive the packets and assemble the debug trace information to perform debugging at the remote system for the computing device 205, for example. In embodiments, the interface controller 208 may notify the controller 204 when it is ready to receive additional packets for communication. For example, the interface controller 208 may complete the transmission of the packets and write to a register 211, such as a status register, over the interface 225 indicating that the previous set of packets has been sent to the remote system.

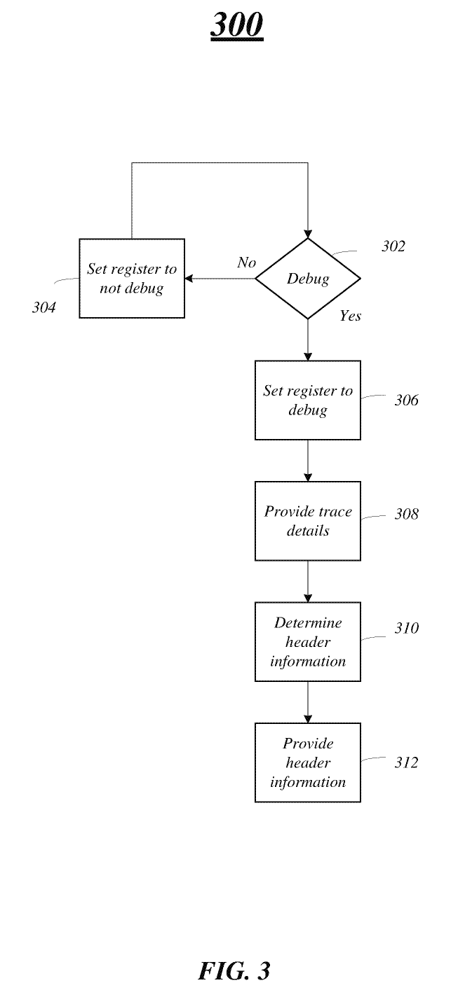

FIG. 3 illustrates an example embodiment of a first logic flow 300. The logic flow 300 may be representative of some or all of the operations executed by one or more embodiments described herein. Further, the logic flow 300 may be performed by processing circuitry, such as processing circuitry of BMC 106/206. Moreover, logic flow 300 may be performed in conjunction with one or more other logic flows discussed herein. Embodiments are not limited in this manner, and one or more operations may be performed by other components of a computing device.

The logic flow 300 may be one example processing flow to operate and configure a computing device to perform debugging and trace operations for the computing device. At block 302, the processing circuitry may determine whether to enable or disable debugging for a computing device and a processor component. For example, the BMC may enable and disable the debugging and trace features for the computing device based on information received from a remote system, such as the datacenter management host. The BMC may receive an indication from the remote system via a BMC LAN interface to turn on/off debugging and tracing for the processor component. In one example, the BMC may receive the indication in one or more Ethernet packets. Note that in some embodiments, the indication may be generated locally, e.g. by an operating system operating on the computing device.

In embodiments, the BMC may configure a processor component to enable/disable debugging and tracing based on the indication. For example, if the BMC determines to disable debugging and tracing, the BMC may configure one or more registers of the processor component such that the processor component does not perform debugging at block 304. Alternatively, if the BMC determines to enable debugging and tracing, the BMC may configure one or more registers of the processor component to cause the processor component to perform debugging at block 306. In embodiments, the BMC may set the one or more registers either to enable or disable debugging via an interface, such as PECI. At block 308, the BMC may provide trace information for the processor component. This may include setting the one or more registers to indicate the signals which need observation and setting up triggers to start/stop tracing on the processor component by the BMC. The processor component may include logic and circuitry to configure debug registers based on PECI mailbox requests coming from the BMC, for example.

At block 310, the BMC may also determine header information for packets including the debug trace information to be communicated to a remote system. In some embodiments, the header information may be determined from the remote system itself, and include Ethernet header information including the address, e.g. internet protocol (IP) address, MAC address and other network address details of the remote system. At block 312, the BMC may provide the header information to a controller, such as a PCH, such that the controller may include the header information in packets to send to the remote system. For example, the BMC may configure or set the header information in one or more registers of the controller. Embodiments may not be limited to the operation illustrated in FIG. 3 and discussed herein. The BMC may perform more or fewer operations to enable/disable debugging for a computing device, for example.

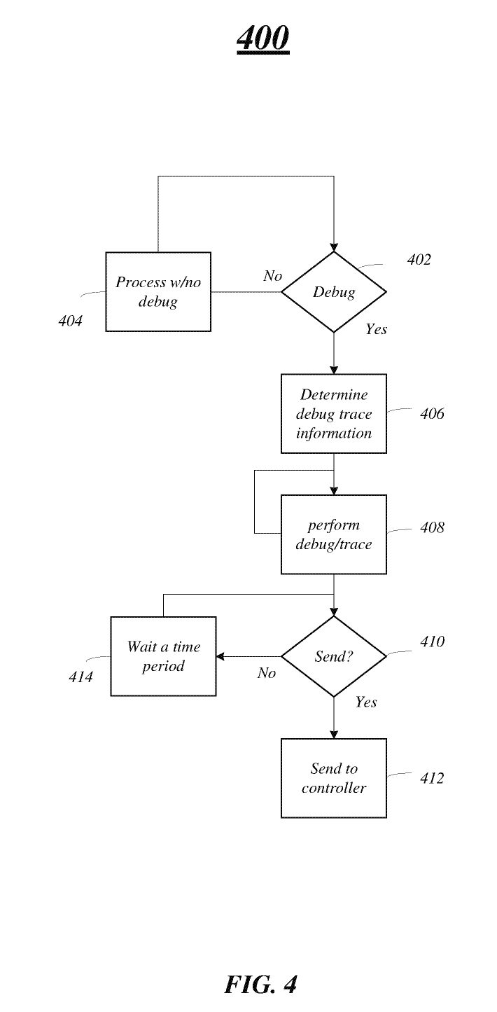

FIG. 4 illustrates an example of second logic flow 400. The logic flow 400 may be representative of some or all of the operations executed by one or more embodiments described herein. Further, the logic flow 400 may be perform on processing circuitry, such as processing circuitry of processor component 102/202. Moreover, logic flow 400 may be performed in conjunction with one or more other logic flows discussed herein. Embodiments are not limited in this manner, and one or more operations may be performed by other components of a computing device.

At block 402, the logic flow 400 may include determining whether debugging and tracing are enabled or disabled for a computing device. For example, the processor component may read one or more registers internal to the processor component to determine whether to perform debugging and tracing. If debugging and tracing are not enabled, the processor component may continue to process information and data without debugging and tracing at block 404. If debugging and tracing are enabled, the processor component may determine the debug trace information to collect to send to a remote system. The processor component may make the determination based one or more settings in one or more registers of the processor component. As previously discussed, the BMC may set one or more registers of the processor component to indicate which signals and components to perform traces and monitor.

At block 408, the processor component may perform debug and trace operations. For example, the processor component including one or more cores may collect the debug trace information by monitoring various threads, processing circuitry, registers, gates, and so forth. The processor component may also receive at least a portion of the debug trace information from other components of a computing device, such as memory, interfaces, controllers, and so forth. In embodiments, the processor component may continuous perform debugging and tracing operations until they are disabled and the computing device is powered off.

At block 410, the processor component may determine whether to send the debug trace information to a controller, such as a PCH, for packetization. For example, the processor component may communicate the debug trace information if a bit is set in a register of the processor comopnent. In some instances, the processor component may also check whether the controller has space available to receive the debug trace information. For example, the debug_credit_avail signal may be driven low (or high based on the logic) by the controller to indicate to the processor component whether space is available. If the processor component cannot send the debug trace information to the controller at block 410, the processor component may wait a period of time at block 414 and then retry to send the debug trace information.

The processor component may send the debug trace information to the controller via pins, which may be low power pins (PTI pins) and couple low power trace transport wires of the processor component to the controller, for example. These pins may can communicate signals, such as the debug_data signal, the debug_vld signal, the debug_clk signal, and the debug_credit_avail signal to communicate the debug trace information. Embodiments are not limited in this manner.

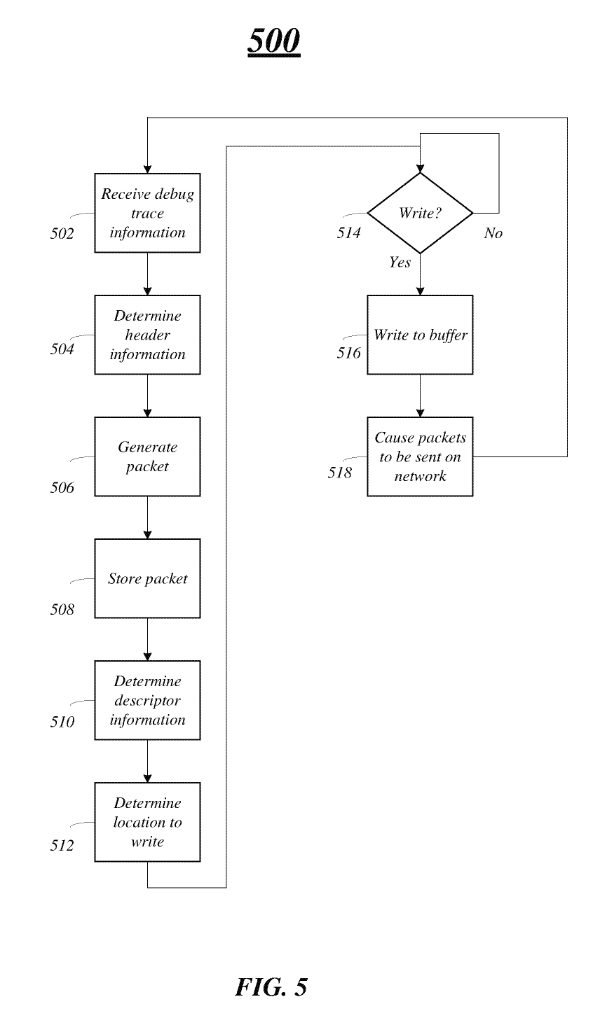

FIG. 5 illustrates an example of a third logic flow 500 to packetize debug trace information and to send the packets to an interface controller for further communication to a remote system. The logic flow 500 may be representative of some or all of the operations executed by one or more embodiments described herein. Further, the logic flow 500 may be performed by processing circuitry, such as processing circuitry of a controller 104/204. Moreover, logic flow 500 may be performed in conjunction with one or more other logic flows discussed herein. Embodiments are not limited in this manner, and one or more operations may be performed by other components of a computing device.

At block 502, a controller, such as a PCH, may receive the debug trace information from a processor component and store the information internally, in memory of the controller. The controller may receive the debug trace information via pins, which may be the low power pins (and packet trace interface (PTI) pins) and couple low power trace transport wires of the processor component to the controller, for example. These pins may can communicate signals, such as the debug_data signal, the debug_vld signal, the debug_clk signal, and the debug_credit_avail signal, as previously discussed.

At block 504, the controller may determine header information to incorporate into packets for the debug trace information. The header information may be set by the BMC in one or more registers of the controller, and the controller may read the registers to determine the header information. The header information may include address information to send packets to a remote system.

At block 506, the controller may generate packets to include the debug trace information. The packets may be of a size and structure to be communicated as Ethernet packets. For example, a packet may include a preamble, a delimiter, a destination identifier, a source identifier, an optional tag, a length, a payload (debug trace information), a frame check sequence, and an interpacket gap, each in a corresponding named field. For example, the controller may include the address of the remote system in the destination field. Moreover, the controller may include other header information in the header of the packet. The controller may also add a sequence number or sequence information to each of the packets to enable the remote system or receiving device to put the packets in the correct sequence. In embodiments, the sequence information indicates a relative location with respect to other packets in a sequence of packets sent to the remote system.

At block 508, the controller may store the packet locally. For example, the controller may store a finalized packet in the controller's memory and registers for communication to an interface controller. In embodiments, the controller may also encrypt each of the one or more packets. To enable secure communication of the packet and their contents, the controller may use a shared key exchanged as part of the secure configuration via the BMC.

At block 510, the controller may perform a handshake with the interface controller to determine descriptor information for the packet. Moreover, the controller assembles packet descriptors that are used by the interface controller to store the packets and send the packets to the remote system. For example, the descriptor information will point to the location in the data buffer storing the packet and used by the interface controller to send the packet to the remote system.

At block 512, the controller may determine a location in the data buffer to store the packets. For example, the controller may determine a base address, which may be the starting address of a data buffer to write the packets. In embodiments, the controller may include one or more registers programmed with the base address of the data buffer by one or more of the BIOS, operating system, an application, etc. The controller may read the base address from the registers. At block 514, the controller may determine whether the packets may be written to the data buffer of the interface controller. For example, the controller may check one of its registers indicating whether the interface controller has space to accept one or more packets. The register may be a preprogrammed register set with a value by the interface controller which tells the controller how many packets the controller can write before waiting for it to be flushed on the network by the interface controller. The interface controller may provide an indication when it flushes the packets to the network. If at block 514 the controller cannot write to the interface controller, the controller may wait until it can.

At block 516, the controller may write the packets to the data buffer. The controller may also write the descriptor information associated with the packets into a descriptor buffer. As mentioned, the descriptor information points to the packets in a data buffer having the packets for communication to the remote system. At block 518, the controller may cause communication of the packets to the remote system. For example, the controller may write to one of the registers of the interface controller, such as Transmit Queue register, to trigger the actual transfer to the remote system. The controller may write to the transmit queue register after completion of the writes of the packets & descriptor information to the interface controller.

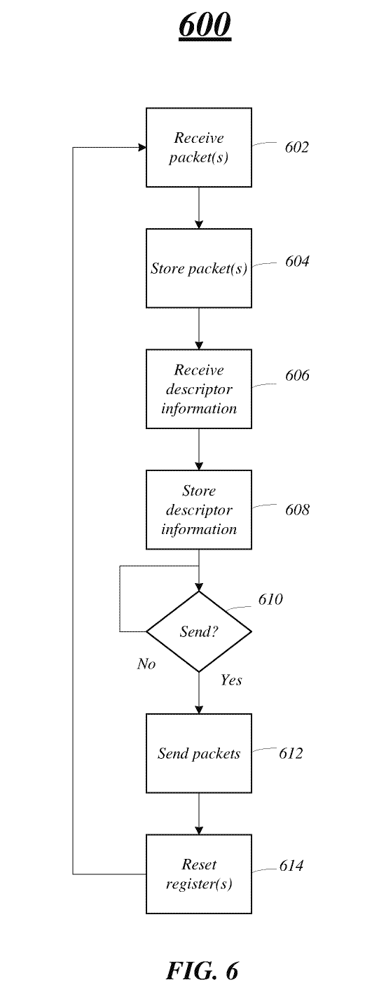

FIG. 6 illustrates an example of a fourth logic flow 600 to receive packets and descriptors and send the packets to a remote system. The logic flow 600 may be representative of some or all of the operations executed by one or more embodiments described herein. Further, the logic flow 600 may be performed by processing circuitry, such as processing circuitry of an interface controller 108/208. Moreover, logic flow 600 may be performed in conjunction with one or more other logic flows discussed herein. Embodiments are not limited in this manner, and one or more operations may be performed by other components of a computing device.

At block 602, an interface controller may receive a packet including debug trace information from a controller, such as a PCH. The packet may be received via an IOSF interface from the controller. At block 604, the interface controller may store the packet in a local memory, such as a data buffer. The interface controller may store the packet in a location based on a base address and indicate by the controller. At block 606, the interface controller may receive descriptor information relating to the packet from the controller. The descriptor information may also be received via an IOSF interface from the controller. The descriptor information may be stored in a descriptor buffer of the interface controller at block 608.

At decision block 610, the interface controller may determine whether to send the packet to a remote system. More specifically, the interface controller may check a register, such as a transmit queue register that may be set by the controller to indicate to the interface controller to send the packet. If the interface controller determines not to send the packet based on the register not indicating to send the packet, the interface controller may and/or process additional packets and descriptors until the packet is ready to be sent as indicated by the controller via the register. At block 612, the interface controller may send the packet to a remote system, e.g. a datacenter management host. In some embodiments, the interface controller may send the packets in one or more frames, such as Ethernet frames to the remote system. At block 614, the interface controller may reset registers, such as the transit queue register, to indicate to the controller that the interface controller is ready to receive and send additional packets. Embodiments are not limited in this manner.

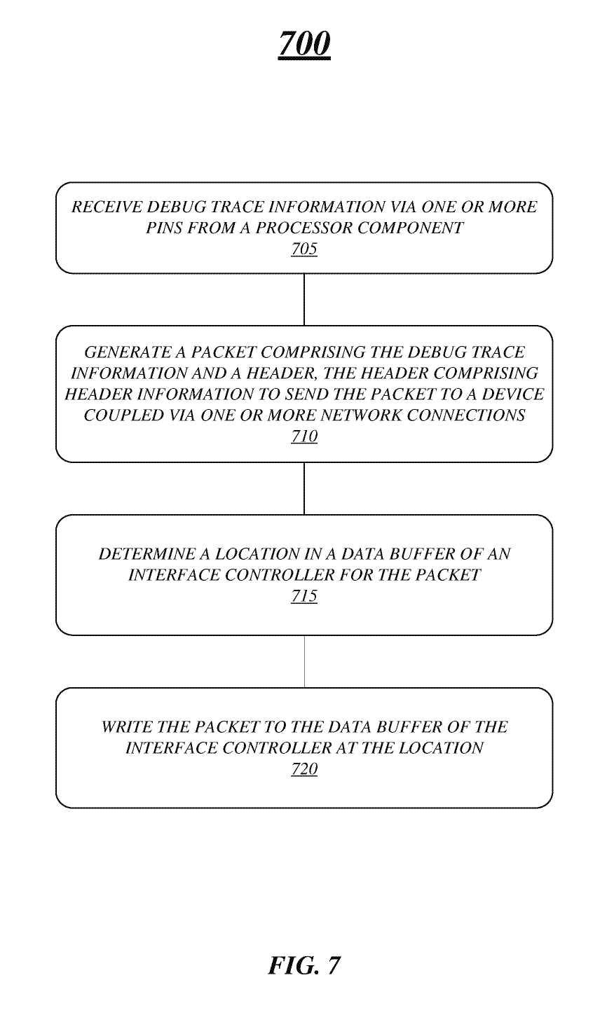

FIG. 7 illustrates an example embodiment of a fifth logic flow 700. The logic flow 700 may be representative of some or all of the operations executed by one or more embodiments described herein. In the illustrated embodiment shown in FIG. 7, the logic flow 700 may include processing debug trace information received via one or more pins at block 705. For example, a controller, such as a PCH controller, may receive debug trace information from a processor component via PTI pins. The PTI pins may be lower power pins to communicate the debug trace information to the controller.

At block 710, the logic flow 700 may include generating a packet comprising the debug trace information and a header, the header comprising header information to send the packet to a device. The packet may be an Ethernet packet and may be sent to a remote system such as a datacenter management host to perform debugging operations. At block 715, the logic flow 700 may include determining a location in a data buffer of an interface controller for the packet. More specifically, a controller may determine a base address to store the packet in the data buffer. The base address may be set in a register of the controller. At block 720, the logic flow 700 may include writing the packet to the data buffer of the interface controller at the location. The controller may send the packet to the interface controller including the data buffer via an interface, such as an IOSF interface. Embodiments are not limited in this manner.

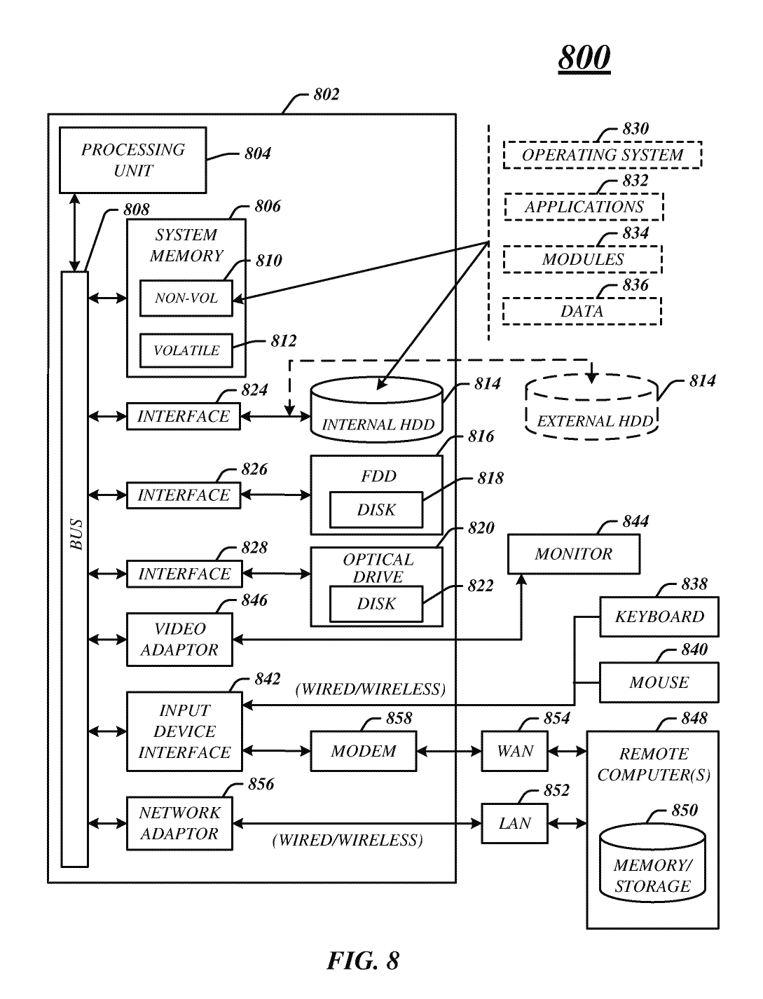

FIG. 8 illustrates an embodiment of an exemplary computing architecture 800 suitable for implementing various embodiments as previously described. In one embodiment, the computing architecture 800 may include or be implemented as part of device 205 and 900, and system 100.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes a processing unit 804, a system memory 806 and a system bus 808. The processing unit 804 can be any of various commercially available processors.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 700.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the device 100 and 800 as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

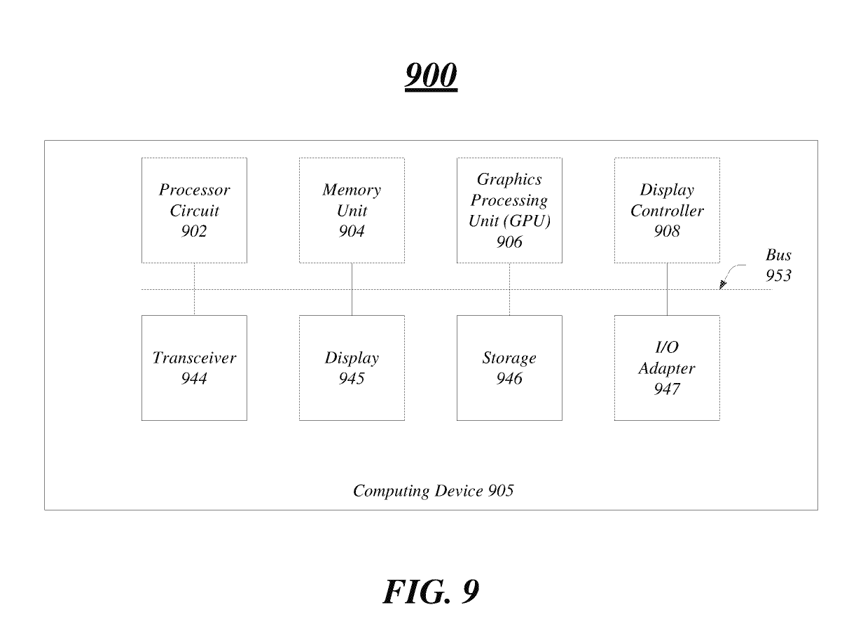

FIG. 9 illustrates one embodiment of a system 900. In various embodiments, system 900 may be representative of a system or architecture suitable for use with one or more embodiments described herein, such as device 100.

As shown in FIG. 9, system 900 may include multiple elements. One or more elements may be implemented using one or more circuits, components, registers, processors, software subroutines, modules, or any combination thereof, as desired for a given set of design or performance constraints. Although FIG. 9 shows a limited number of elements in a certain topology by way of example, it can be appreciated that more or less elements in any suitable topology may be used in system 900 as desired for a given implementation. The embodiments are not limited in this context.

In various embodiments, system 900 may include a computing device 905 which may be any type of computer or processing device including a personal computer, desktop computer, tablet computer, netbook computer, notebook computer, laptop computer, server, server farm, blade server, or any other type of server, and so forth.

Examples of a computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

In various embodiments, computing device 905 may include processor circuit 902. Processor circuit 902 may be implemented using any processor or logic device. The processing circuit 902 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 902 may be connected to and communicate with the other elements of the computing system via an interconnect 743, such as one or more buses, control lines, and data lines.

In one embodiment, computing device 905 may include a memory unit 904 to couple to processor circuit 902. Memory unit 904 may be coupled to processor circuit 902 via communications bus 953, or by a dedicated communications bus between processor circuit 902 and memory unit 904, as desired for a given implementation. Memory unit 04 may be implemented using any machine-readable or computer-readable media capable of storing data, including both volatile and non-volatile memory. In some embodiments, the machine-readable or computer-readable medium may include a non-transitory medium. The embodiments are not limited in this context.

Computing device 905 may include a graphics processing unit (GPU) 906, in various embodiments. The GPU 906 may include any processing unit, logic or circuitry optimized to perform graphics-related operations as well as the video decoder engines and the frame correlation engines. The GPU 906 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 906 may process any type of graphics data such as pictures, videos, programs, animation, 3D, 2D, objects images and so forth.

In some embodiments, computing device 905 may include a display controller 908. Display controller 908 may be any type of processor, controller, circuit, logic, and so forth for processing graphics information and displaying the graphics information. The display controller 908 may receive or retrieve graphics information from one or more buffers. After processing the information, the display controller 908 may send the graphics information to a display.

In various embodiments, system 900 may include a transceiver 944. Transceiver 944 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 944 may operate in accordance with one or more applicable standards in any version. The embodiments are not limited in this context.

In various embodiments, computing device 905 may include a display 945. Display 945 may constitute any display device capable of displaying information received from processor circuit 902, graphics processing unit 906 and display controller 908.

In various embodiments, computing device 905 may include storage 946. Storage 946 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 946 may include technology to increase the storage performance enhanced protection for valuable digital media when multiple hard drives are included, for example. Further examples of storage 946 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 905 may include one or more I/O adapters 947. Examples of I/O adapters 947 may include Universal Serial Bus (USB) ports/adapters, IEEE 1394 Firewire ports/adapters, and so forth. The embodiments are not limited in this context.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The detailed disclosure now turns to providing examples that pertain to further embodiments. Examples one through thirty-three provided below are intended to be exemplary and non-limiting.

In a first example, a system, a device, an apparatus, and so forth to include processing circuitry, and memory comprising, that when executed by the processing circuitry, to cause the processing circuitry to receive debug trace information via one or more pins from a processor component, generate a packet comprising the debug trace information and a header, the header comprising header information to send the packet to a device coupled via one or more network connections, determine a location in a data buffer of an interface controller for the packet, and write the packet to the data buffer of the interface controller at the location.

In a second example and in furtherance of the first example, a system, a device, an apparatus, and so forth to include the processing circuitry to perform a handshake with the interface controller to determine descriptor information, and write the descriptor information to a descriptor buffer of the interface controller, the descriptor information to point to the location in the data buffer storing the packet.

In a third example and in furtherance of any previous example, a system, a device, an apparatus, and so forth to include the processing circuitry to determine header information based on header information set in a register by a baseboard management controller, the header information comprising an address for the device.

In a fourth example and in furtherance of any previous example, a system, a device, an apparatus, and so forth to include the processing circuitry to cause storage of the packet in the one or more registers prior to writing the packet in the data buffer.

In a fifth example and in furtherance of any previous example, a system, a device, an apparatus, and so forth to include the processing circuitry to determine a base address in the data buffer based on information set in a register by one or more of a basic input/output system (BIOS), an operating system, and an application, the base address for use to determine descriptor information, and the location to store the packet based on the base address.

In a sixth example and in furtherance of any previous example, a system, a device, an apparatus, and so forth to include the processing circuitry to append sequence information to the packet, the sequence information to indicate a relative location with respect to other packets in a sequence of packets comprising the debug trace information.

In a seventh example and in furtherance of any previous example, a system, a device, an apparatus, and so forth to include the one or more pins comprising packet trace interface (PTI) pins, the PTI pins comprising one or more of a debug_data pin to receive the debug trace information, a debug_vld pin to receive an indication as to whether the debug trace information is valid, a debug_clk pin to receive a clock signal, and a debug_credit_Avail pin to indicate whether space is available in memory for the debug trace information.

In an eight example and in furtherance of any previous example, a system, a device, an apparatus, and so forth to include the processing circuitry to write to a register of the interface controller to cause communication of one or more packets including the packet to the device.

In a ninth example and in furtherance of any previous example, a system, a device, an apparatus, and so forth to include the one or more pins to receive the debug trace information as one or more signals from a processor component, and one or more registers.

In a tenth example and in furtherance of any previous example, embodiments may include a computer-implemented method including receiving debug trace information via one or more pins, generating a packet comprising the debug trace information and a header, the header comprising header information to send the packet to a device coupled via one or more network connections, determining a location in a data buffer of an interface controller for the packet, and writing the packet to the data buffer of the interface controller at the location.

In an eleventh example and in furtherance of any previous example, embodiments may include a computer-implemented method including performing a handshake with the interface controller to determine descriptor information, and writing the descriptor information to a descriptor buffer of the interface controller, the descriptor information to point to the location in the data buffer storing the packet.

In a twelfth example and in furtherance of any previous example, embodiments may include a computer-implemented method including determining header information based on header information set in a register by a baseboard management controller, the header information comprising an address for the device.

In a thirteenth example and in furtherance of any previous example, embodiments may include a computer-implemented method including causing storage of the packet in memory prior to writing the packet in the data buffer.

In a fourteenth example and in furtherance of any previous example, embodiments may include a computer-implemented method including determining a base address in the data buffer based on information set in a register by one or more of a basic input/output system (BIOS), an operating system, and an application, the base address for use to determine descriptor information, and the location to store the packet based on the base address.

In a fifteenth example and in furtherance of any previous example, embodiments may include a computer-implemented method including appending sequence information to the packet, the sequence information to indicate a relative location with respect to other packets in a sequence of packets comprising the debug trace information.

In a sixteenth example and in furtherance of any previous example, embodiments may include a computer-implemented method including communicating the one or more pins are packet trace interface (PTI) pins, the PTI pins comprising one or more of a debug_data pin to receive the debug trace information, a debug_vld pin to receive an indication as to whether the debug trace information is valid, a debug_clk pin to receive a clock signal, and a debug_credit_Avail pin to indicate whether space is available in memory for the debug trace information.

In a seventeenth example and in furtherance of any previous example, embodiments may include a computer-implemented method including writing to a register of the interface controller to cause communication of one or more packets including the packet to the device.

In an eighteenth example and in furtherance of any previous example, embodiments include a non-transitory computer-readable storage medium, comprising a plurality of instructions, that when executed, enable processing circuitry to receive debug trace information via one or more pins, generate a packet comprising the debug trace information and a header, the header comprising header information to send the packet to a device coupled via one or more network connections, determine a location in a data buffer of an interface controller for the packet, and write the packet to the data buffer of the interface controller at the location.

In a nineteenth example and in furtherance of any previous example, embodiments include a non-transitory computer-readable storage medium, comprising a plurality of instructions, that when executed, enable processing circuitry to perform a handshake with the interface controller to determine descriptor information, and write the descriptor information to a descriptor buffer of the interface controller, the descriptor information to point to the location in the data buffer storing the packet.

In a twentieth example and in furtherance of any previous example, embodiments include a non-transitory computer-readable storage medium, comprising a plurality of instructions, that when executed, enable processing circuitry to determine header information based on header information set in a register by a baseboard management controller, the header information comprising an address for the device.

In a twenty-first example and in furtherance of any previous example, embodiments include a non-transitory computer-readable storage medium, comprising a plurality of instructions, that when executed, enable processing circuitry to storage of the packet in memory prior to writing the packet in the data buffer.

In a twenty-second example and in furtherance of any previous example, embodiments include a non-transitory computer-readable storage medium, comprising a plurality of instructions, that when executed, enable processing circuitry to determine a base address in the data buffer based on information set in a register by one or more of a basic input/output system (BIOS), an operating system, and an application, the base address for use to determine descriptor information, and the location to store the packet based on the base address.

In a twenty-third example and in furtherance of any previous example, embodiments include a non-transitory computer-readable storage medium, comprising a plurality of instructions, that when executed, enable processing circuitry to append sequence information to the packet, the sequence information to indicate a relative location with respect to other packets in a sequence of packets comprising the debug trace information.

In a twenty-fourth example and in furtherance of any previous example, embodiments include a non-transitory computer-readable storage medium, comprising a plurality of instructions, that when executed, enable processing circuitry to communicate via the one or more pins which are packet trace interface (PTI) pins, the PTI pins comprising one or more of a debug_data pin to receive the debug trace information, a debug_vld pin to receive an indication as to whether the debug trace information is valid, a debug_clk pin to receive a clock signal, and a debug_credit_Avail pin to indicate whether space is available in memory for the debug trace information.

In a twenty-fifth example and in furtherance of any previous example, embodiments include a non-transitory computer-readable storage medium, comprising a plurality of instructions, that when executed, enable processing circuitry to write to a register of the interface controller to cause communication of one or more packets including the packet to the device.

In a twenty-sixth example and in furtherance of any previous example, a system, a device, an apparatus, and so forth to include means for receiving debug trace information via one or more pins from a processor components, means for generating a packet comprising the debug trace information and a header, the header comprising header information to send the packet to a device coupled via one or more network connections, means for determining a location in a data buffer of an interface controller for the packet, and means for writing the packet to the data buffer of the interface controller at the location.

In a twenty-seventh example and in furtherance of any previous example, a system, a device, an apparatus, and so forth to include means for performing a handshake with the interface controller to determine descriptor information, and write the descriptor information to a descriptor buffer of the interface controller, the descriptor information to point to the location in the data buffer storing the packet.

In a twenty-eighth example and in furtherance of any previous example, a system, a device, an apparatus, and so forth to include means for determining header information based on header information set in a register by a baseboard management controller, the header information comprising an address for the device.

In a twenty-ninth example and in furtherance of any previous example, a system, a device, an apparatus, and so forth to include means for causing storage of the packet in memory prior to writing the packet in the data buffer.

In a thirtieth example and in furtherance of any previous example, a system, a device, an apparatus, and so forth to include means for determining a base address in the data buffer based on information set in a register by one or more of a basic input/output system (BIOS), an operating system, and an application, the base address for use to determine descriptor information, and the location to store the packet based on the base address.

In a thirty-first example and in furtherance of any previous example, a system, a device, an apparatus, and so forth to include means for appending sequence information to the packet, the sequence information to indicate a relative location with respect to other packets in a sequence of packets comprising the debug trace information.

In a thirty-second example and in furtherance of any previous example, a system, a device, an apparatus, and so forth to include means for receiving the debug trace information, means for receiving an indication as to whether the debug trace information is valid, means for receiving a clock signal, and means for indicating whether space is available in memory for the debug trace information.

In a thirty-third example and in furtherance of any previous example, a system, a device, an apparatus, and so forth to include means for writing to a register of the interface controller to cause communication of one or more packets including the packet to the device.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
processing circuitry; and
memory comprising one or more instructions, that when executed by the processing circuitry, to cause the processing circuitry to:
receive debug trace information via one or more pins from a processor component;
generate a packet comprising the debug trace information and a header, the header comprising header information to send the packet to a device accessible via one or more network connections;
determine a location in a data buffer of an interface controller for the packet; and
write the packet to the data buffer of the interface controller at the location.

2. The apparatus of claim 1, the processing circuitry to perform a handshake with the interface controller to determine descriptor information, and write the descriptor information to a descriptor buffer of the interface controller, the descriptor information to point to the location in the data buffer storing the packet.

3. The apparatus of claim 1, the processing circuitry to determine header information based on header information set in a register by a baseboard management controller, the header information comprising an address for the device.

4. The apparatus of claim 1, the processing circuitry to cause storage of the packet in memory prior to writing the packet in the data buffer.

5. The apparatus of claim 1, the processing circuitry to determine a base address in the data buffer based on information set in a register by one or more of a basic input/output system (BIOS), an operating system, and an application, the base address for use to determine descriptor information, and the location to store the packet based on the base address.

6. The apparatus of claim 1, the processing circuitry to append sequence information to the packet, the sequence information to indicate a relative location with respect to other packets in a sequence of packets comprising the debug trace information.

7. The apparatus of claim 1, wherein the one or more pins are packet trace interface (PTI) pins, the PTI pins comprising one or more of a debug_data pin to receive the debug trace information, a debug_vld pin to receive an indication as to whether the debug trace information is valid, a debug_clk pin to receive a clock signal, and a debug_credit_Avail pin to indicate whether space is available in memory for the debug trace information.

8. The apparatus of claim 1, the processing circuitry to write to a register of the interface controller to cause communication of one or more packets including the packet to the device.

9. The apparatus of claim 1, comprising:
the one or more pins to receive the debug trace information as one or more signals from a processor component; and
one or more registers.

10. A computer-implemented method, comprising:
receiving debug trace information via one or more pins;
generating a packet comprising the debug trace information and a header, the header comprising header information to send the packet to a device accessible via one or more network connections;
determining a location in a data buffer of an interface controller for the packet; and
writing the packet to the data buffer of the interface controller at the location.

11. The computer-implemented method of claim 10, comprising:
performing a handshake with the interface controller to determine descriptor information; and
writing the descriptor information to a descriptor buffer of the interface controller, the descriptor information to point to the location in the data buffer storing the packet.

12. The computer-implemented method of claim 10, comprising determining header information based on header information set in a register by a baseboard management controller, the header information comprising an address for the device.

13. The computer-implemented method of claim 10, comprising causing storage of the packet in memory prior to writing the packet in the data buffer.

14. The computer-implemented method of claim 10, comprising determining a base address in the data buffer based on information set in a register by one or more of a basic input/output system (BIOS), an operating system, and an application, the base address for use to determine descriptor information, and the location to store the packet based on the base address.

15. The computer-implemented method of claim 10, comprising appending sequence information to the packet, the sequence information to indicate a relative location with respect to other packets in a sequence of packets comprising the debug trace information.

16. The computer-implemented method of claim 10, wherein the one or more pins are packet trace interface (PTI) pins, the PTI pins comprising one or more of a debug_data pin to receive the debug trace information, a debug_vld pin to receive an indication as to whether the debug trace information is valid, a debug_clk pin to receive a clock signal, and a debug_credit_Avail pin to indicate whether space is available in memory for the debug trace information.

17. The computer-implemented method of claim 10, comprising writing to a register of the interface controller to cause communication of one or more packets including the packet to the device.

18. A non-transitory computer-readable storage medium, comprising a plurality of instructions, that when executed, enable processing circuitry to:
receive debug trace information via one or more pins;
generate a packet comprising the debug trace information and a header, the header comprising header information to send the packet to a device accessible via one or more network connections;
determine a location in a data buffer of an interface controller for the packet; and
write the packet to the data buffer of the interface controller at the location.

19. The computer-readable storage medium of claim 18, comprising a plurality of instructions, that when executed, enable processing circuitry to:
perform a handshake with the interface controller to determine descriptor information; and
write the descriptor information to a descriptor buffer of the interface controller, the descriptor information to point to the location in the data buffer storing the packet.

20. The computer-readable storage medium of claim 18, comprising a plurality of instructions, that when executed, enable processing circuitry to determine header information based on header information set in a register by a baseboard management controller, the header information comprising an address for the device.

21. The computer-readable storage medium of claim 18, comprising a plurality of instructions, that when executed, enable processing circuitry to storage of the packet in memory prior to writing the packet in the data buffer.

22. The computer-readable storage medium of claim 18, comprising a plurality of instructions, that when executed, enable processing circuitry to determine a base address in the data buffer based on information set in a register by one or more of a basic input/output system (BIOS), an operating system, and an application, the base address for use to determine descriptor information, and the location to store the packet based on the base address.

23. The computer-readable storage medium of claim 18, comprising a plurality of instructions, that when executed, enable processing circuitry to append sequence information to the packet, the sequence information to indicate a relative location with respect to other packets in a sequence of packets comprising the debug trace information.

24. The computer-readable storage medium of claim 18, wherein the one or more pins are packet trace interface (PTI) pins, the PTI pins comprising one or more of a debug_data pin to receive the debug trace information, a debug_vld pin to receive an indication as to whether the debug trace information is valid, a debug_clk pin to receive a clock signal, and a debug_credit_Avail pin to indicate whether space is available in memory for the debug trace information.

25. The computer-readable storage medium of claim 18, comprising a plurality of instructions, that when executed, enable processing circuitry to write to a register of the interface controller to cause communication of one or more packets including the packet to the device.
